(19) United States
(12) Patent Application Publication
(10) Pub. No.: US 2016/0136926 A1
(43) Pub. Date: May 19, 2016

(54) Non-Weft Cloth, Manufacturing Method Therefor, And Non-Weft Cloth Product

(71) Applicant: ZHENGZHOU ZHONGYUAN DEFENSE MATERIAL CO., LTD, Zhengzhou (CN)

(72) Inventors: Changgan Ji, Zhengzhou (CN); Ruiwen Yen, Zhengzhou (CN); Junying Ma, Zhengzhou (CN)

(73) Assignee: Zhengzhou Zhongyuan Defense Material Co., Ltd, Zhengzhou (CN)

(21) Appl. No.: 14/900,091

(22) PCT Filed: Jun. 20, 2013
(86) PCT No.: PCT/CN2013/077550

§ 371 Date: Dec. 18, 2015

(51) Int. Cl. B32B 7/00; B32B 37/14; B32B 27/08; B32B 27/32; B32B 7/04; B32B 7/12

(52) U.S. Cl. CPC B32B 7/005; B32B 7/04; B32B 7/12; B32B 27/08; B32B 27/32; B32B 37/14; B32B 2250/242; B32B 2571/02; B32B 2309/105

(57) ABSTRACT

The invention relates to a non-weft cloth, a manufacturing method thereof and a non-weft cloth product. The method comprises: crisscross compounding and laminating multiple ultra-high molecular weight polyethylene thin films at certain angles into a whole to obtain the non-weft cloth; and as macromolecular straight chain structures in the ultra-high molecular weight polyethylene thin films are uniformly distributed, the probability of causing damages to the interior of the thin films in the manufacturing process of the non-weft cloth is relatively low, the defects of breaking, distortion, intertwining, knotting, non-uniform arrangement and the like can be avoided, when the non-weft cloth prepared on the basis of the ultra-high molecular weight polyethylene thin films is subject to external force impact, the ultra-high molecular weight polyethylene thin films are stressed as a whole, and force-bearing points can be diffused to force-bearing surfaces rapidly to effectively transfer energy, thereby improving the strength of the non-weft cloth and improving the bulletproof performance and other protection performances thereof.

### FIELD OF THE INVENTION

The invention relates to a manufacturing process of a chemical fiber fabric, in particular to a non-weft cloth, a manufacturing method therefor and a non-weft cloth product.

### BACKGROUND OF THE INVENTION

Ultra-high molecular weight polyethylene (referred to as UHMW-PE) is a thermoplastic engineering plastic with a linear structure and excellent comprehensive performances, and one of important uses of the material is to prepare a high-strength fiber on the basis of the material.

An ultra-high molecular weight polyethylene (UHMW-PE) fiber is a synthetic fiber, its molecular structure has very high straightening parallelism and degree of orientation, and such molecular structure determines that the ultra-high molecular weight polyethylene fiber has a very high strength and modulus and has the advantages of good chemical stability, corrosion resistance and the like. The above properties of the ultra-high molecular weight polyethylene (UHMW-PE) fiber have exceeded those of an aramid fiber plain weave fabric, and the ultra-high molecular weight polyethylene fiber is widely applied in the field of bulletproof protection for military and polices and has become a mainstream material replacing a traditional steel structure bulletproof material in the field.

The strength of a unidirectional cloth (also known as UD cloth) is centralized in a certain direction. A non-weft cloth can be prepared by laminating multiple unidirectional cloths at certain fiber axis rotation angles. At present, the non-weft cloth prepared from ultra-high molecular weight polyethylene fibers is generally prepared by adopting the following process: tidily arranging multiple ultra-high molecular weight polyethylene fibers by a warping process of realizing uniformity, parallelism, straightness and the like, bonding the fibers with glue to prepare the unidirectional cloth, sequentially crisscross spreading at least two layers of the multi-layer unidirectional cloth according to 0 degree or 90 degrees and bonding the unidirectional cloths with the glue to prepare the non-weft cloth.

The existing process uses a large amount of glue, the process for bonding the glue with the ultra-high molecular weight polyethylene fibers is complex, and the production efficiency of the unidirectional cloth is further reduced. In addition, as each ultra-high molecular weight polyethylene fiber has a tow-like structure and each ultra-high molecular weight polyethylene fiber is an independent individual, the warping process of the fibers is complex, the production cost is high, the fibers are liable to production of breaking, distortion, intertwining, knotting, non-uniform arrangement and other defects in warping, coating and other process flows, these defects will hinder the effective energy transfer of external force by the non-weft cloth, and the strength, the bulletproof performance and other performances of the non-weft cloth are further reduced.

### SUMMARY OF THE INVENTION

A brief summary of the invention is given below to facilitate the basic understanding of some aspects of the invention. It should be understood that the summary is not an exhaustive summary of the invention. It is not intended to determine key or important parts of the invention or limit the scope of the invention. It only aims at presenting some concepts in a simplified form as a prelude to the more detailed description which will be discussed later.

The invention provides a non-weft cloth with low cost and improved fabric strength, a manufacturing method therefor and a non-weft cloth product.

In the first aspect, the invention provides a manufacturing method of a non-weft cloth, comprising:

crisscross compounding and laminating multiple ultra-high molecular weight polyethylene thin films at certain angles into a whole to obtain the non-weft cloth.

Optionally, crisscross compounding and laminating the multiple ultra-high molecular weight polyethylene thin films at the certain angles into the whole comprises:

crisscross laminating and spreading the ultra-high molecular weight polyethylene thin films at certain angles and hot-pressing or bonding overlapped parts of the multiple ultra-high molecular weight polyethylene thin films.

Optionally, the intersection angles of any two adjacent ultra-high molecular weight polyethylene thin films are the same.

Optionally, the intersection angles are 0-90 degrees.

Optionally, the intersection angles are 45 degrees or 90 degrees.

Optionally, the intersection angles of at least two ultra-high molecular weight polyethylene thin films of the ultra-high molecular weight polyethylene thin films are different from the intersection angles of other ultra-high molecular weight polyethylene thin films.

Optionally, the intersection angles of every two adjacent ultra-high molecular weight polyethylene thin films from the first ultra-high molecular weight polyethylene thin film to the last ultra-high molecular weight polyethylene thin film gradually increase.

Optionally, the related parameters of the ultra-high molecular weight polyethylene thin film at least meet one or more of the following conditions:

the linear density is above 5000 deniers;

the width is above 100 mm;

the thickness is below 0.2 mm;

the breaking strength is above 10 grams/denier;

the tensile modulus is above 800 grams/denier; and

the elongation at break is below 6%.

In the second aspect, the invention further provides a non-weft cloth which is prepared by adopting the above manufacturing method.

In the third aspect, the invention further provides a non-weft cloth product which is prepared from the above non-weft cloth.

In the embodiment, the ultra-high molecular weight polyethylene thin film is a thin slice which is prepared from ultra-high molecular weight polyethylene and has a certain width and thickness, wherein the width is much greater than the thickness, and it has an integral structure without integration points or trim lines.

In the embodiment of the invention, the non-weft cloth is prepared on the basis of the ultra-high molecular weight polyethylene thin films, so that a trivial process for warping treatment of the fibers respectively can be eliminated, the amount of the glue is also obviously reduced, the manufacturing process of the non-weft cloth is simplified, the production cost is reduced and the production efficiency is improved.

In addition, as macromolecular straight chain structures in the ultra-high molecular weight polyethylene thin films are uniformly distributed, the probability of causing damages to the interior of the thin films in the manufacturing process of the non-weft cloth is relatively low, the defects of breaking, distortion, intertwining, knotting, non-uniform arrangement and the like can be avoided, and when the non-weft cloth prepared on the basis of the ultra-high molecular weight polyethylene thin films is subject to external force impact, the ultra-high molecular weight polyethylene thin films are stressed as a whole, and force-bearing points can be diffused to force-bearing surfaces rapidly to effectively transfer energy, thereby improving the strength of the non-weft cloth and improving the bulletproof performance and other protection performances therefor.

These and other advantages of the invention will be evident through the following detailed description of optional embodiments of the invention in conjunction with the accompanying drawings.

### BRIEF DESCRIPTION OF THE DRAWINGS

The invention can be better understood through the following description in conjunction with the accompanying drawings, wherein the same or similar reference symbols are used throughout the drawings to represent the same or similar parts. The accompanying drawings in conjunction with the detailed description below are included in the description and form one part of the specification, and are used for further illustrating the optional embodiments of the invention and explaining the principle and the advantages of the invention. In the drawings:

FIG. 1 is a flow diagram of an embodiment of a manufacturing method of a non-weft cloth provided by the invention.

FIG. 2 is a structural schematic diagram of a first embodiment of a non-weft cloth provided by the invention.

FIG. 3 is a structural schematic diagram of a second embodiment of the non-weft cloth provided by the invention.

FIG. 4 is a structural schematic diagram of a fourth embodiment of the non-weft cloth provided by the invention.

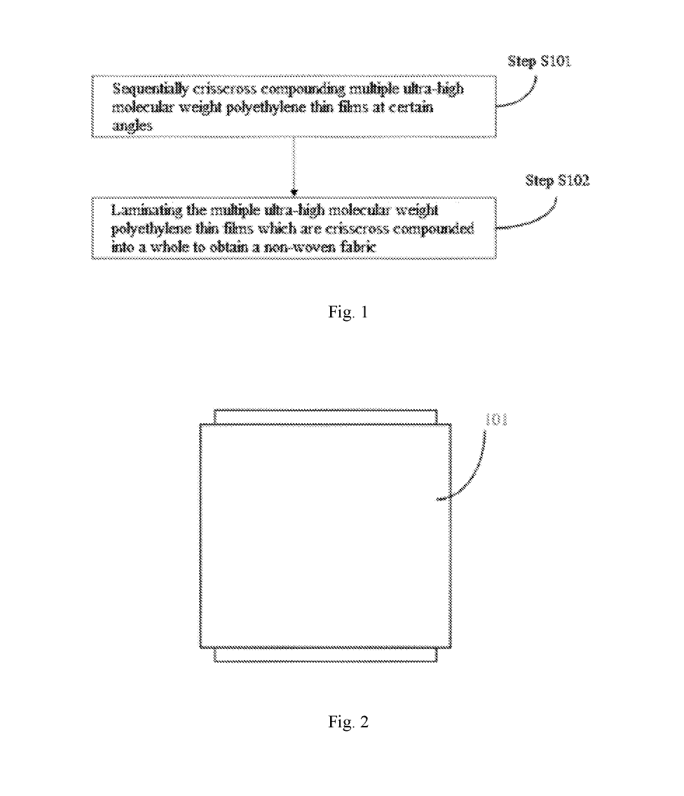

Those of skilled in the art should understand that elements in the accompanying drawings are only illustrated for simplicity and clarity, and are not necessarily drawn to scale. For example, the sizes of some elements in the accompanying drawings may be exaggerated relative to other elements so as to assist in improvement of the understanding of the embodiments of the invention.

### DETAILED DESCRIPTION OF THE EMBODIMENTS

The exemplary embodiments of the invention will be described in detail below in conjunction with the accompanying drawings. For clarity and brevity, not all the characteristics of the actual implementation ways are described in the description. However, it should be understood that, in the process of developing any of these actual embodiments, many decisions which are specific to the implementation ways must be made to facilitate the implementation of specific objectives of development persons, such as meeting those system and business related limitation conditions, and these limitation conditions may vary between the different implementation ways. In addition, it should also be understood that, although the development work may be very complex and time-consuming, the development work is just a routine task for those skilled in the art and benefiting from the disclosure of the invention.

Herein, it still needs to be noted that, in order to prevent the unnecessary details from obscuring the invention, only the device structure and/or the treatment steps which are closely related to the solutions of the invention are described in the accompanying drawings and the description, and the representations and the descriptions of the parts and the treatments which are not closely related to the invention and known to those of ordinary skill in the art are omitted.

The technical solutions provided by various embodiments of the invention are essentially different from the traditional technologies of ultra-high molecular weight polyethylene application and are revolutionary innovations against the traditional technologies, namely the ultra-high molecular weight polyethylene thin films are used for replacing the ultra-high molecular weight fibers to develop and prepare the non-weft cloth, and the core concept mainly comprises: the ultra-high molecular weight polyethylene thin films are used for replacing the traditional ultra-high molecular weight polyethylene fibers to prepare the non-weft cloth.

In this case, the ultra-high molecular weight polyethylene thin film is a thin slice which is prepared from ultra-high molecular weight polyethylene and has a certain width and thickness, wherein the width is much greater than the thickness.

The ultra-high molecular weight polyethylene thin films provided by the invention are different from the ultra-high molecular weight polyethylene fibers and also different from a plane formed by bonding the multiple ultra-high molecular weight polyethylene fibers, and the significant difference is that: the ultra-high molecular weight polyethylene thin film provided by the invention has a certain width and thickness and has an integral structure without integration points or trim lines.

The non-weft cloth provided in each embodiment of the invention is prepared on the basis of the ultra-high molecular weight polyethylene thin films. In the manufacturing process, a complex process for respectively arranging multiple fiber silks is eliminated, the probability of producing burrs on the surfaces of the thin films or strips is obviously reduced and the probability of breaking, distortion, intertwining and other phenomena in the thin films is also obviously reduced. When bearing a load, the ultra-high molecular weight polyethylene thin films are stressed as a whole, so that the strength of the non-weft cloth is relatively high and the strength utilization ratio is effectively improved. Thus, the strength of the non-weft cloth prepared on the basis of the ultra-high molecular weight polyethylene thin films is higher than that of a product prepared by adopting the ultra-high molecular weight polyethylene fibers with the same denier number, the cost of the former is obviously lower than the latter, and the non-weft cloth has the advantages of good structural integrity, high strength, high strength utilization ratio, high production efficiency, low processing cost, light weight, small surface density, good flexibility and the like.

The technical solutions of the invention are further described by taking the optional structures of the rope and the manufacturing method therefor as examples below in conjunction with the accompanying drawings.

### Embodiment 1

The embodiment provides a manufacturing method of a non-weft cloth, comprising: step S101, sequentially crisscross compounding multiple ultra-high molecular weight polyethylene thin films; and

step S102, laminating the multiple ultra-high molecular weight polyethylene thin films which are crisscross compounded into a whole to obtain the non-weft cloth.

The core concept of the embodiment is that, the ultra-high molecular weight polyethylene thin films are used for directly replacing traditional ultra-high molecular weight polyethylene fibers to prepare the non-weft cloth.

The ultra-high molecular weight polyethylene thin films described in the various embodiments of the invention adopt polyethylene with molecular weight of above 1 million.

In the embodiment, the ultra-high molecular weight polyethylene thin film is a thin slice which is prepared from ultra-high molecular weight polyethylene and has a certain width and thickness, wherein the width is much greater than the thickness, and the ultra-high molecular weight polyethylene thin film has an integral structure without integration points or trim lines.

The ultra-high molecular weight polyethylene thin films provided by the embodiment replace unidirectional cloth prepared from the ultra-high molecular weight polyethylene fibers by a traditional process, so that a trivial process for warping treatment of the various fibers can be eliminated, the amount of the glue is also obviously reduced, the manufacturing process of the non-weft cloth is simplified, the production cost is reduced and the production efficiency is improved.

The multiple ultra-high molecular weight polyethylene thin films are crisscross laminated and spread at the certain angles and overlapped parts of the multiple ultra-high molecular weight polyethylene thin films are hot-pressed or bonded.

By adopting the bonding way, one surface of each ultra-high molecular weight polyethylene thin film is coated with an adhesive, the other surface of each ultra-high molecular weight polyethylene thin film is not coated with the adhesive, and one surface coated with the adhesive of one ultra-high molecular weight polyethylene thin film is bonded with the surface which is not coated with the adhesive of another ultra-high molecular weight polyethylene thin film.

By adopting the hot-pressing way, the control conditions for hot-pressing are as follows: the temperature is 50-130° C. and/or the pressure is 1-15 MPa; by adopting the hot-pressing way, the coating of the adhesive is not required, thereby being conductive to simplifying the process, reducing the cost and improving the production efficiency; and furthermore, as the hot-pressing temperature is lower than a melting point of the ultra-high molecular weight polyethylene thin films or strips, damages can be avoided.

Optionally, the intersection angles of any two adjacent ultra-high molecular weight polyethylene thin films are the same, and the intersection angles are 0-90 degrees.

Further, the intersection angles are 45 degrees or 90 degrees.

Optionally, the intersection angles of at least two layers of the ultra-high molecular weight polyethylene thin films are different from the intersection angles of other ultra-high molecular weight polyethylene thin films.

Further, the intersection angles of every two adjacent ultra-high molecular weight polyethylene thin films from the first ultra-high molecular weight polyethylene thin film to the last ultra-high molecular weight polyethylene thin film gradually increase, and the non-weft cloth prepared by adopting the way can be applied to, but is not limited to manufacturing of bulletproof helmets.

The formed non-weft cloth can be formed by compounding two layers, or compounding four layers or compounding eight layers.

Optionally, the related parameters of the ultra-high molecular weight polyethylene thin film provided in each embodiment of the invention at least meet one or more of the following conditions:

the linear density is above 5000 deniers;

the width is above 100 mm;

the thickness is below 0.2 mm;

the breaking strength is above 10 grams/denier;

the tensile modulus is above 800 grams/denier; and

the elongation at break is below 6%.

According to the manufacturing method of the non-weft cloth provided by the embodiment, the ultra-high molecular weight polyethylene thin films are adopted to prepare the non-weft cloth, so that a trivial process for warping treatment of the various fibers can be eliminated, the amount of the glue is also obviously reduced, the manufacturing process of the non-weft cloth is further simplified, the process is simple, the production cost is low, and the prepared non-weft cloth can be applied to the fields of national defense military, individual protection and civil use, such as bulletproof floors of helicopters, armored seats, reinforced cabinet doors, armored protection plates of tanks and ships, anti-scrap liners, synthetic anti-ballistic armors of tracked vehicles, tactical vehicles and commercial armored vehicles, housings of bulletproof cash carrying vehicles and armored weapons, protective housing covers of radars, bulletproof vests, bulletproof insert plates, helmets, bulletproof and puncture-proof clothes, bulletproof and explosion-proof suitcases and other high-strength composite materials, such as high-strength suitcases, crashproof poles for automobiles and the like.

### Embodiment 2

The embodiment provides a non-weft cloth which is formed by crisscross compounding and laminating multiple ultra-high molecular weight polyethylene thin films at certain angles wherein the intersection angles of any two adjacent ultra-high molecular weight polyethylene thin films are the same.

Further, the intersection angles are 0-90 degrees.

Further, the intersection angles are 45 degrees or 90 degrees.

As an optional implementation way, as shown in FIG. 2, the multiple ultra-high molecular weight polyethylene thin films 101 are compounded and laminated to form the non-weft cloth, and the intersection angles of every two adjacent ultra-high molecular weight polyethylene thin films 101 are 90 degrees.

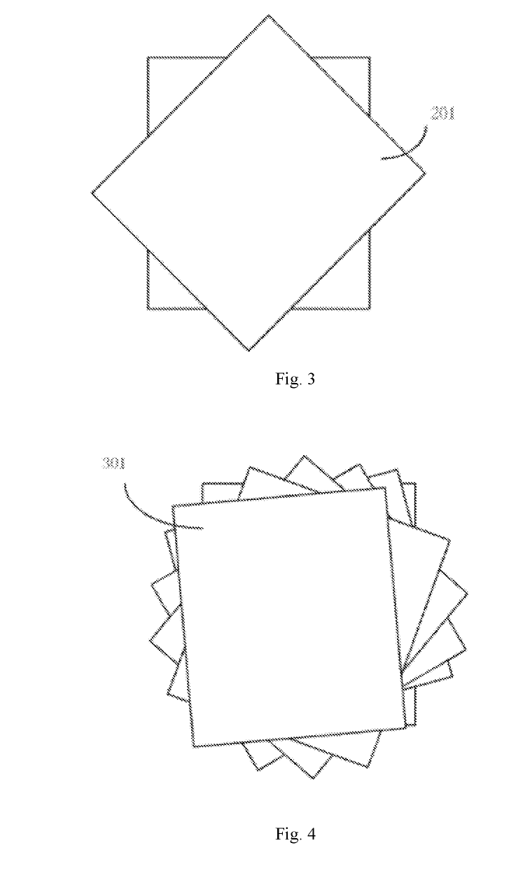

As an optional implementation way, as shown in FIG. 3, the multiple ultra-high molecular weight polyethylene thin films 201 are compounded and laminated to form the non-weft cloth, and the intersection angles of every two adjacent ultra-high molecular weight polyethylene thin films 201 are 45 degrees.

Overlapped parts of the two adjacent ultra-high molecular weight polyethylene thin films are connected in a bonding or hot-pressing way; in the bonding way, one surface of each ultra-high molecular weight polyethylene thin film is coated with glue, the other surface is not coated with the glue, and one surface coated with the glue of one ultra-high molecular weight polyethylene thin film is bonded with the surface which is not coated with the glue of another ultra-high molecular weight polyethylene thin film; and in the hot-pressing way, the control conditions for hot pressing are as follows: the temperature is 50-130° C. and/or the pressure is 1-15 MPa.

As macromolecular straight chain structures in the ultra-high molecular weight polyethylene thin films are uniformly distributed, the probability of causing damages to the interior of the thin films in the manufacturing process of the non-weft cloth is relatively low, the defects of breaking, distortion, intertwining, knotting, non-uniform arrangement and the like can be avoided, and when the non-weft cloth prepared on the basis of the ultra-high molecular weight polyethylene thin films is subject to external force impact, the ultra-high molecular weight polyethylene thin films are stressed as a whole, and force-bearing points can be diffused to force-bearing surfaces rapidly to effectively transfer energy, thereby improving the strength of the non-weft cloth and improving the bulletproof performance and other protection performances therefor.

The non-weft cloth provided by the embodiment is formed by compounding the ultra-high molecular weight polyethylene thin films, so that a trivial process for warping treatment of the various fibers can be eliminated, the amount of the glue is also obviously reduced, the manufacturing process of the non-weft cloth is further simplified, the process is simple, and the production cost is low; and when the non-weft cloth is subject to external force impact, the ultra-high molecular weight polyethylene thin films are stressed as a whole, and force-bearing points can be diffused to force-bearing surfaces rapidly to effectively transfer energy, so that the non-weft cloth has the advantages of a high strength, great modulus, small creep property, a relatively small stress concentration influence scope along the edge direction of the thin films and the like and can be widely applied to the fields of national defense military, individual protection and civil use, such as bulletproof floors of helicopters, armored seats, reinforced cabinet doors, armored protection plates of tanks and ships, anti-scrap liners, synthetic anti-ballistic armors of tracked vehicles, tactical vehicles and commercial armored vehicles, housings of bulletproof cash carrying vehicles and armored weapons, protective housing covers of radars, bulletproof vests, bulletproof insert plates, helmets, bulletproof and puncture-proof clothes, bulletproof and explosion-proof suitcases and other high-strength composite materials, such as high-strength suitcases, crashproof poles for automobiles and the like.

### Embodiment 3

The embodiment provides a non-weft cloth which is formed by crisscross compounding and laminating multiple ultra-high molecular weight polyethylene thin films at certain angles. The intersection angles of at least two ultra-high molecular weight polyethylene thin films of the ultra-high molecular weight polyethylene thin films are different from the intersection angles of other ultra-high molecular weight polyethylene thin films.

As shown in FIG. 4, the multiple ultra-high molecular weight polyethylene thin films 301 are compounded and laminated to form the non-weft cloth, the intersection angles of every two adjacent ultra-high molecular weight polyethylene thin films from the first ultra-high molecular weight polyethylene thin film to the last ultra-high molecular weight polyethylene thin film gradually increase, and the non-weft cloth prepared by adopting the way is mainly applied to manufacturing of helmets.

The helmet prepared from the non-weft cloth provided in the embodiment has high strength and excellent bulletproof performance.

Overlapped parts of the two adjacent ultra-high molecular weight polyethylene thin films are connected by adopting a bonding or hot-pressing way; by adopting the bonding way, one surface of each ultra-high molecular weight polyethylene thin film is coated with glue, the other surface is not coated with the glue, and one surface coated with the glue of one ultra-high molecular weight polyethylene thin film is bonded with the surface which is not coated with the glue of another ultra-high molecular weight polyethylene thin film; and by adopting the hot-pressing way, the control conditions for hot pressing are as follows: the temperature is 50-130° C. and/or the pressure is 1-15 MPa.

### Embodiment 4

The embodiment provides a non-weft cloth product which is prepared from a non-weft cloth, and the non-weft cloth is formed by crisscross compounding and laminating multiple ultra-high molecular weight polyethylene thin films at certain angles.

The non-weft cloth product provided by the embodiment can be used for, but is not limited to bulletproof floors of helicopters, armored seats, reinforced cabinet doors, armored protection plates of tanks and ships, anti-scrap liners, synthetic anti-ballistic armors of tracked vehicles, tactical vehicles and commercial armored vehicles, housings of bulletproof cash carrying vehicles and armored weapons, protective housing covers of radars, bulletproof vests, bulletproof insert plates, helmets, bulletproof and puncture-proof clothes, bulletproof and explosion-proof suitcases and other high-strength composite materials, such as high-strength suitcases, crashproof poles for automobiles and the like.

As for the non-weft cloth product provided by the embodiment, as the non-weft cloth is prepared from the ultra-high molecular weight polyethylene thin films, when being subject to external force impact, the ultra-high molecular weight polyethylene thin films or strips are stressed as a whole, and force-bearing points can be diffused to force-bearing surfaces rapidly to effectively transfer energy. Thus, the non-weft cloth product prepared from the non-weft cloth has higher strength and better bulletproof performance.

Although the invention and the advantages thereof have been described in detail, it should be understood that various changes, substitutions and modifications can be made without exceeding the spirit and the scope of the invention limited by the appended claims.

Finally, it need to be noted that, the relation terms, such as first, second and the like herein are only used to differentiate one entity or operation from another entity or operation, and do not necessarily require or imply that these entities or operations have any actual relation or sequence. Furthermore, terms “including”, “comprising” or any other variations thereof are intended to cover non-exclusive inclusion, so that the process, method, the object or the equipment including a series of elements comprises not only those elements, but also other elements which are not listed clearly, or further comprise the inherent elements of the process, the method, the object or the equipment. Without more limitations, the element limited by the wording “including one . . . ” does not exclude that the process, the method, the object or the equipment including the element further has other identical elements.

Although the embodiments of the invention have been described in detail in conjunction with the accompanying drawings, it should be understood that the implementation ways described above are only used for describing the invention rather than limiting the invention. For those skilled in the art, various modifications and changes can be made to the above implementation ways without deviating from the spirit and the scope of the invention. Thus, the scope of the invention is only limited by the appended claims and equivalents thereof.

1. A manufacturing method of a non-weft cloth, comprising: crisscross compounding and laminating multiple ultra-high molecular weight polyethylene thin films at certain angles into a whole to obtain the non-weft cloth.

2. The manufacturing method of the non-weft cloth according to claim 1, characterized in that crisscross compounding and laminating the multiple ultra-high molecular weight polyethylene thin films at the certain angles into the whole comprises:
crisscross laminating and spreading the ultra-high molecular weight polyethylene thin films at certain angles and hot-pressing or bonding overlapped parts of the multiple ultra-high molecular weight polyethylene thin films.

3. The manufacturing method of the non-weft cloth according to claim 1, characterized in that the intersection angles of any two adjacent ultra-high molecular weight polyethylene thin films are the same.

4. The manufacturing method of the non-weft cloth according to claim 3, characterized in that the intersection angles are 0-90 degrees.

5. The manufacturing method of the non-weft cloth according to claim 4, characterized in that the intersection angles are 45 degrees or 90 degrees.

6. The manufacturing method of the non-weft cloth according to claim 1, characterized in that the intersection angles of at least two ultra-high molecular weight polyethylene thin films of the ultra-high molecular weight polyethylene thin films are different from the intersection angles of other ultra-high molecular weight polyethylene thin films.

7. The manufacturing method of the non-weft cloth according to claim 6, characterized in that the intersection angles of every two adjacent ultra-high molecular weight polyethylene thin films from the first ultra-high molecular weight polyethylene thin film to the last ultra-high molecular weight polyethylene thin film gradually increase.

8. The manufacturing method of the non-weft cloth according to claim 1, characterized in that the related parameters of the ultra-high molecular weight polyethylene thin film at least meet one or more of the following conditions:
the linear density is above 5000 deniers;
the width is above 100 mm;
the thickness is below 0.2 mm;
the breaking strength is above 10 grams/denier;
the tensile modulus is above 800 grams/denier; and
the elongation at break is below 6%.

9. A non-weft cloth, prepared by the manufacturing method of the non-weft cloth according to claim 1.

10. A non-weft cloth product, prepared from the non-weft cloth according to claim 9.
